(19) United States
(12) Patent Application Publication
(10) Pub. No.: US 2023/0137657 A1
(43) Pub. Date: May 4, 2023

(54) METHOD FOR DISPLAYING RESULT OF DOCUMENT RECOGNITION AND APPARATUS USING SAME

(71) Applicant: SAMSUNG SDS CO., LTD., Seoul (KR)

(72) Inventors: Hyoseob SONG, Seoul (KR); Seongho JOE, Seoul (KR); Youngjune GWON, Seoul (KR)

(73) Assignee: SAMSUNG SDS CO., LTD., Seoul (KR)

(21) Appl. No.: 17/976,177

(22) Filed: Oct. 28, 2022

(30) Foreign Application Priority Data
Oct. 29, 2021 (KR) 10-2021-0146786

(51) Int. Cl. G06V 30/40; G06F 18/21; G06V 30/148

(52) U.S. Cl. CPC G06V 30/40; G06F 18/217; G06V 30/153

(57) ABSTRACT

The present disclosure relates to a method for displaying a document recognition result and a document recognition apparatus using same, wherein a method performed by a processor in a computing apparatus for displaying a document recognition result according to an embodiment of the present disclosure may include: extracting text from an input document image and matching multiple key values and values included in the text to generate key-value pairs; on the basis of a configured output item, extracting a key-value pair corresponding to the output item from the document image; and adding a highlight object to an area corresponding to the extracted key-value pair in the document image to generate a first image and displaying the first image.

CROSS-REFERENCE TO RELATED APPLICATION(S)

This application is based on and claims priority under 35 U.S.C. 119 to Korean Patent Application No. 10-2021-0146786, filed on Oct. 29, 2021, in the Korean Intellectual Property Office, the disclosure of which is herein incorporated by reference in its entirety.

### BACKGROUND OF THE INVENTION

### 1. Field of the Invention

The present disclosure relates to a method for displaying a document recognition result and a document recognition apparatus using same, which can effectively provide text extracted from a document image to a user.

### 2. Description of the Prior Art

Optical character recognition (OCR) technology is a technology for deriving a digitized result by recognizing a portion corresponding to a character existing in an input document. Character recognition with respect to a document image may search for a specific key word, etc. included in the corresponding document image possible so that it is possible to easily extract necessary information from the document in a form of an image. However, the conventional art provided only a function to find a specific keyword included in a document image and thus has a problem in that a specific UI for using a character-recognized document image is not implemented.

### SUMMARY OF THE INVENTION

The present disclosure is to provide a method for displaying a document recognition result and a document recognition apparatus using same, wherein output items to be extracted from a document image through document recognition are visually displayed in the document image to allow a user to intuitively recognize same.

Further, the present disclosure is to provide a method for displaying a document recognition result and a document recognition apparatus using same, wherein a user can quickly and easily browse and print required information by allowing the user to easily add, delete, or change output items to be extracted from a document image.

Also, the present disclosure is to provide a method for displaying a document recognition result and a document recognition apparatus using same, which can intensively provide an extraction result for output items necessary for a user's business processing rather than recognizing all the characters included in the document image.

A method performed by a processor in a computing apparatus for displaying a document recognition result according to an embodiment of the present disclosure may include: extracting text from an input document image and matching multiple key values and values included in the text to generate key-value pairs; on the basis of a configured output item, extracting a key-value pair corresponding to the output item from the document image; and adding a highlight object to an area corresponding to the extracted key-value pair in the document image to generate a first image and displaying the first image.

In the displaying the first image, generating a table indicating a key value and a value included in the key-value pair corresponding to the output item is generated and is additionally included in the displayed first image.

In the displaying the first image, when the input document image is added, a key value and a value corresponding to the key-value pair extracted from each document image may be accumulated to the table.

In the extracting a key-value pair, a key-value pair having a key value corresponding to the output item may be searched from among the key-value pairs to extract the key-value pair.

In the extracting a key-value pair, a key value corresponding to the output item may be searched by using a preconfigured concordance mapping DB and a key-value pair corresponding to the output item may be extracted by using the searched key value.

The method for displaying a document recognition result according to an embodiment of the present disclosure may further include receiving an add or delete input with respect to the output item from a user and configuring the output item.

In the configuring the output item, the list of the output items and an item display area including a selection object for adding or deleting output items to/from the list may be additionally added to be displayed.

The method for displaying a document recognition result according to an embodiment of the present disclosure may further include generating and providing the table in a file form of at least one of JSON, XML, Excel and PDF.

The method for displaying a document recognition result according to an embodiment of the present disclosure may include: displaying a thumbnail display area for displaying a thumbnail image of respective input document images; and when one thumbnail image in the thumbnail display area is selected, displaying a document image corresponding to the selected thumbnail image within a selection image area.

A computer-readable storage medium according to an embodiment of the present disclosure may store instructions that, when executed by a processor, cause an apparatus including the processor to perform an operation for displaying a document recognition result, wherein the operation includes: extracting text from an input document image and matching multiple key values and values included in the text to generate key-value pairs; on the basis of a configured output item, extracting a key-value pair corresponding to the output item from the document image; and adding a highlight object to an area corresponding to the extracted key-value pair in the document image to generate a first image and displaying the first image.

In the displaying the first image, a table indicating a key value and a value included in the key-value pair corresponding to the output item may be generated and included in the displayed first image.

In the displaying the first image, when the input document image is added, a key value and a value corresponding to the key-value pair extracted from each document image may be accumulated to the table.

A document recognition apparatus according to an embodiment of the present disclosure may be an apparatus including a processor and the processor may configured to: extract text from an input document image and match multiple key values and values included in the text to generate key-value pairs; on the basis of a configured output item, extract a key-value pair corresponding to the output item from the document image; and add a highlight object to an area corresponding to the extracted key-value pair in the document image to generate a first image and display the first image.

In the displaying the first image, generating a table indicating a key value and a value included in the key-value pair corresponding to the output item is generated and is additionally included in the displayed first image.

In the displaying the first image, when the input document image is added, a key value and a value corresponding to the key-value pair extracted from each document image may be accumulated to the table.

In the extracting a key-value pair, a key-value pair having a key value corresponding to the output item may be searched from among the key-value pairs to extract the key-value pair.

In the extracting a key-value pair, a key value corresponding to the output item may be searched by using a preconfigured concordance mapping DB and a key-value pair corresponding to the output item may be extracted by using the searched key value.

The document recognition apparatus according to an embodiment of the present disclosure may be configured to further perform receiving an add or delete input with respect to the output item from a user and configuring the output item.

In the configuring the output item, the list of the output items and an item display area including a selection object for adding or deleting output items to/from the list may be additionally added to be displayed.

The document recognition apparatus according to an embodiment of the present disclosure may be configured to further perform generating and providing the table in a file form of at least one of JSON, XML, Excel and PDF.

Further, the above-described technical solutions to the problems are not all of the features of the present disclosure. Various features of the present disclosure and advantages and effects thereof will be more fully understood by reference to following specific exemplary embodiments.

By the method for displaying a document recognition result and the document recognition apparatus using same according to an embodiment of the present disclosure, an output item to be extracted from a document image is visually displayed in the document image and thus a user can intuitively recognize output items being extracted from the current document image.

By the method for displaying a document recognition result and the document recognition apparatus using same according to an embodiment of the present disclosure, a user can easily add, delete, or change output items to be extracted from a document image. That is, a user can easily configure desired output items and thus the user can easily browse and print only the necessary information from the document image.

By the method for displaying a document recognition result and the document recognition apparatus using same according to an embodiment of the present disclosure, rather than recognizing all the characters included in the document image, an extraction result for output items necessary for a user's business processing can be intensively provided. Therefore, it is possible to provide user experience (UX) that allows users to perform more efficient business processing.

It will be appreciated by a person skilled in the art that the effects of the method for displaying a document recognition result and the document recognition apparatus using same according to embodiments of the present disclosure, which may be achieved based on various embodiments, are not limited to the effects described above and other effects that are not described above will be clearly understood from the following detailed description.

### BRIEF DESCRIPTION OF THE DRAWINGS

FIG. 1 is a block diagram illustrating a document recognition apparatus according to an embodiment of the present disclosure;

FIG. 2 is an exemplary view illustrating a document image according to an embodiment of the present disclosure;

FIG. 3 is an exemplary view illustrating a method for providing a basic item of a document recognition apparatus as an output item according to an embodiment of the present disclosure;

FIG. 4 is an exemplary view illustrating a method for providing a basic item of a document recognition apparatus as an output item according to an embodiment of the present disclosure;

FIG. 5 is an exemplary view illustrating a method for providing a basic item of a document recognition apparatus as an output item according to an embodiment of the present disclosure;

FIG. 6 is an exemplary view illustrating a method for providing a basic item of a document recognition apparatus as an output item according to an embodiment of the present disclosure;

FIG. 7 is an exemplary view illustrating a method for providing a basic item of a document recognition apparatus as an output item according to an embodiment of the present disclosure;

FIG. 8 is an exemplary view illustrating a method for providing an additional output item in addition to a basic item of a document recognition apparatus according to an embodiment of the present disclosure;

FIG. 9 is an exemplary view illustrating a method for providing an additional output item in addition to a basic item of a document recognition apparatus according to an embodiment of the present disclosure;

FIG. 10 is an exemplary view illustrating an initial page of a document recognition apparatus according to an embodiment of the present disclosure;

FIG. 11 is a flowchart illustrating a method for displaying a document recognition result according to an embodiment of the present disclosure; and

FIG. 12 is a view illustrating an exemplary hardware configuration diagram of a computing apparatus in which methods according to various embodiments of the present disclosure may be implemented.

### DETAILED DESCRIPTION OF THE EXEMPLARY EMBODIMENTS

Hereinafter, various embodiments of the present disclosure will be described in detail with reference to accompanying drawings. The objects, specific advantages and novel features of the present disclosure will become more apparent from the following detailed description and preferred embodiments taken in conjunction with the accompanying drawings.

Prior to the description, the terms or words used in the present specification and claims should be construed as meanings and concepts consistent with the technical spirit of the present disclosure as the inventor has appropriately defined the concept in order to best explain the disclosure. They are for illustrative purposes only, and should not be construed as limiting the present invention.

In assigning reference numerals to the components, the same or similar components are given the same reference numerals regardless of the reference numerals, and redundant description thereof will be omitted. Herein, the suffixes “module” and “unit” for the elements used in the following description are given or used in common by considering facilitation in writing this disclosure only but fail to have meanings or roles discriminated from each other, and may be referred as software or hardware elements.

In describing elements of the present disclosure, when an element is expressed in a singular form, it should be understood that the element also includes a plural form unless otherwise specified. As used herein, such terms as “first” and “second” may be used to simply distinguish a corresponding component from another, and does not limit the components in other aspect. When it is described that one element is connected to another element, it means that still another element may be connected between the element and the another element.

In the following description of the disclosure, a detailed description of the related prior art incorporated herein will be omitted when it is determined that the description may make the subject matter of embodiments disclosed in the disclosure unclear. The accompanying drawings are only for easy understanding of the embodiments disclosed in the present specification, and the technical ideas disclosed in the present specification are not limited by the accompanying drawings and it should be understood to include all modifications, equivalents and substitutes included in the spirit and scope of the present disclosure.

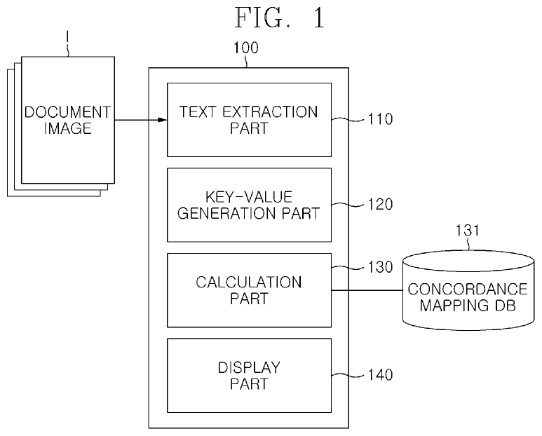

FIG. 1 is a block diagram illustrating a document recognition apparatus according to an embodiment of the present disclosure.

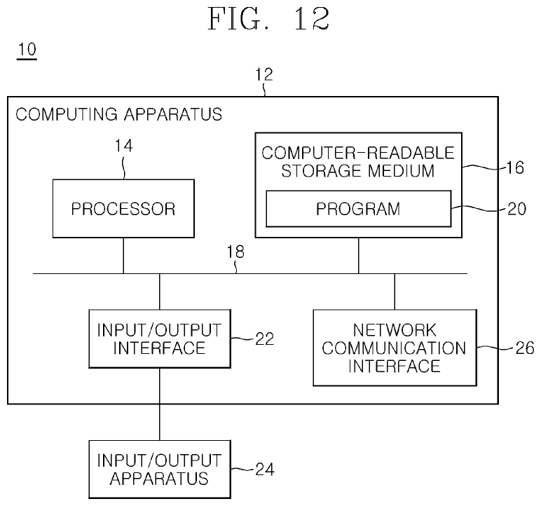

Referring to FIG. 1, the document recognition apparatus 100 may include a text extraction part 110, a key-value pair generation part 120, a calculation part 130, and a display part 140. The document recognition apparatus 100 and the components 110-140 included in same may be implemented through a computing apparatus shown in FIG. 12.

Hereinafter, the document recognition apparatus according to an embodiment of the present disclosure will be described with reference to FIG. 1.

The text extraction part 110 may extract text by performing character recognition with respect to an input document image I. That is, the text extraction part 110 may recognize characters included in the document image I by using a character recognition algorithm such as optical character recognition (OCR) and extract a recognition result as text. Any character recognition algorithm may be applied to the text extraction part 110 as long as the algorithm can extract text from the document image I.

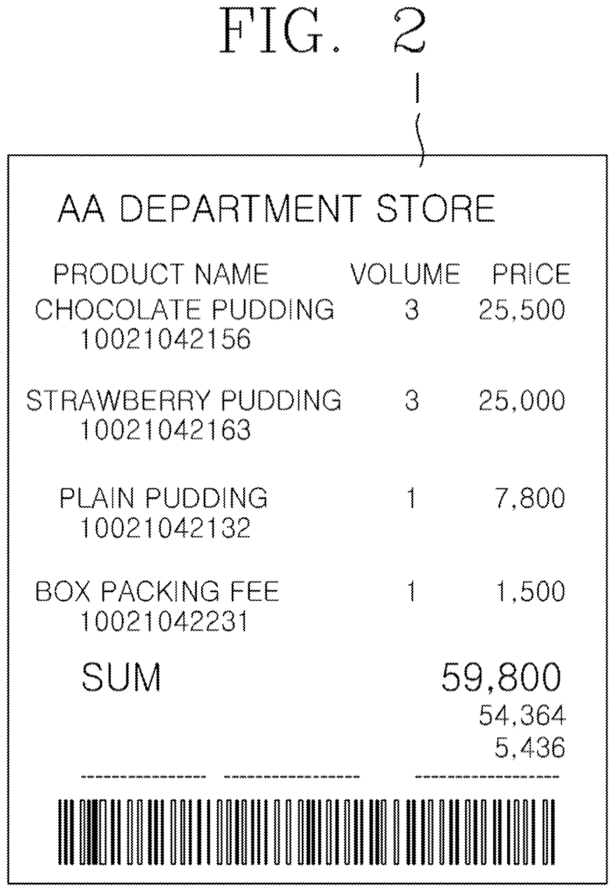

The key-value pair generation part 120 may match multiple key values and values included in the text extracted by the text extraction part 110 and generate a key-value pair. Referring to FIG. 2, a receipt may be received as the document image I, and a key value and a value may be extracted from texts included in the receipt and matched to each other. Specifically, among texts extracted from the receipt, “Product name”, “Price”, “Sum”, and the like corresponding to key values and values corresponding to the key value “Product name” correspond to “Chocolate Pudding”, “Strawberry Pudding”, “Plain Pudding”, “Box Packing Fee”. Values corresponding to the key value “Price” are “25,500”, “25,500”, “7,000”, “1,000”, and a value corresponding to the key value “Sum”corresponds to “59,800”.

Here, relationship between the key value and the value may be configured in consideration of a position between the key value and the value, and depending on an embodiment, it is also possible to match in consideration of the semantic similarity between the key value and the value. The key-value pair generation part 120 may match each extracted key value and value on the basis of a preconfigured rule or match through machine learning based on a neural network model or the like.

When a key value is omitted from the document image I, it is possible to create a key value and match the key value with a value. “AA department store” in FIG. 2 corresponds to a value, but a corresponding key value is not included in the receipt. Accordingly, the key-value pair generation part 120 may generate “Business name” as a key value and then match “Business name” and “AA department store”to generate a key-value pair.

The calculation part 130 may extract a key-value pair corresponding to output items from the document image I on the basis of a preconfigured output item. The output item corresponds to an item desired to be displayed to a user among texts included in the document image I. Depending on an embodiment, among the output items, basic items to be displayed to a user may have been configured.

For example, “Company name” and “Total Amount” may be configured as a basic item, and in this case, the calculation part 130 may search a key-value pair having a key value corresponding to “Company Name”which is an output item from among key-value pairs. Thereafter, when there is a key value corresponding to “Company Name” among the key-value pairs generated by the key-value pair generation part 120, the corresponding key-value pair may be extracted.

Each document image I may be non-standardized and thus terms used in the document images I may be different from each other. That is, for the same output item, respective document images I may use different terms. For example, for a term corresponding to “Total Amount” of the output items, each receipt may use different words such as “Total”, “Sales Total”, and “Receipt Amount”. Here, when the calculation part 130 uses only the text extracted from the document image I, searching for a key value corresponding to an output item may fail.

In order to prevent the above-described problem, the document recognition apparatus 100 may use a concordance mapping database (DB) 131. That is, key-values corresponding to output items may be searched by using a preconfigured concordance mapping DB 131, and a key-value pair corresponding to an output item may be extracted by using the searched key value. For example, all of “Total”, “Sales Total”, and “Receipt Amount” may be stored in the concordance mapping DB 131 as corresponding to the output item “Total Amount”, and thus, it is possible to extract key value pairs with key values of “Total”, “Sales Total”, and “Receipt Amount” in addition to “Total Amount” as key value pairs corresponding to the output item “Total Amount”.

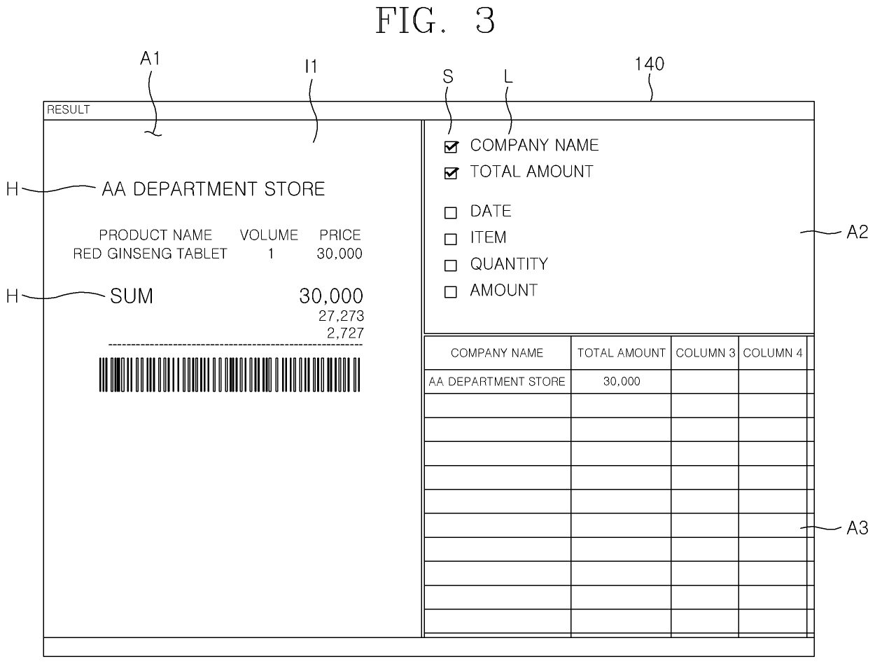

According to feedback of a user, the calculation part 130 may add other items in addition to the basic items or delete or modify at least a portion of the basic items to update output items. That is, the calculation part 130 may receive an add or delete input with respect to output items from a user and modify and configure the output items according thereto. As shown in FIG. 3, the calculation part 130 may generate an item display area A2 including a list L of output items and a selection object S with respect to each output item. Thereafter, an item display area A2 may be displayed through the display part 140. That is, a user may easily identify output items from the item display area A2 and select or deselect desired output items.

Thereafter, the calculation part 130 may add a highlight object to an area corresponding to the extracted key-value pair in the document image I to generate a first image. That is, as shown in FIG. 3, a highlight object H may be added to visually display the selected output item to a user. The highlight object H may correspond to adding a highlight, a bounding box, shading, or the like to an area corresponding to an output item. Depending on an embodiment, the calculation part 130 may adjust the color, font, and font size of corresponding text.

The calculation part 130 may implement the first image including the highlight object H to be displayed to a user through the display part 140. When a user adds or deletes an output item through the selection object S or the like, the calculation part 130 may modify and display a location of the highlight object H in the first image according to the selected output item.

In addition, the calculation part 130 may generate a table indicating a key value and a value included in a key-value pair corresponding to the output item. That is, by providing an output item that a user wants to check through a separate table, it is possible to conveniently provide information required by the user among various information included in the document image I.

Specifically, referring to FIG. 3, the table may be included in a table area A3. Output items selected by a user may be displayed in a first row of the table, values corresponding to each of the output items may be input and displayed in the table. That is, “Business name”-“AA department store” which is the key-value pair corresponding to the output item “Company Name” may be extracted from a first receipt I1, and a value “AA department store” may be added as a value for the output item “Company Name”. Furthermore, after “Total”-“30,000” which is a key-value pair corresponding to an output item “Total Amount” is extracted, a value “30,000” is added as a value for an output item “Total Amount” to generate a table.

Depending on an embodiment, the table generated by the calculation part 130 may be provided to a user in a form of file, and various types of files such as JSON, XML, Excel, and PDF may be generated according to a user input.

Multiple documents I may be input to the document recognition apparatus 100, and the calculation part 130 may accumulate and display a key value and a value corresponding to the key-value pair extracted from the added document image I in the table.

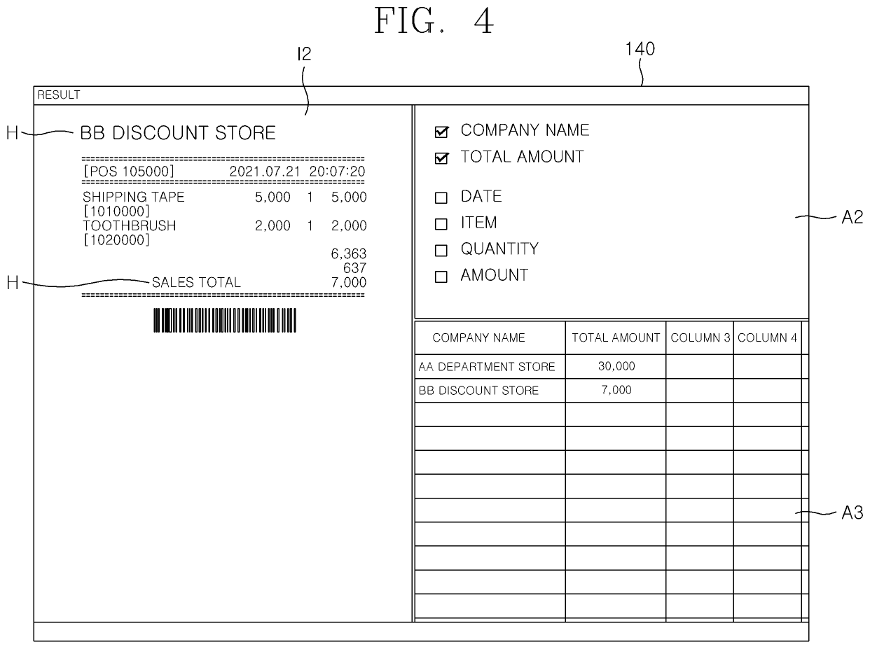

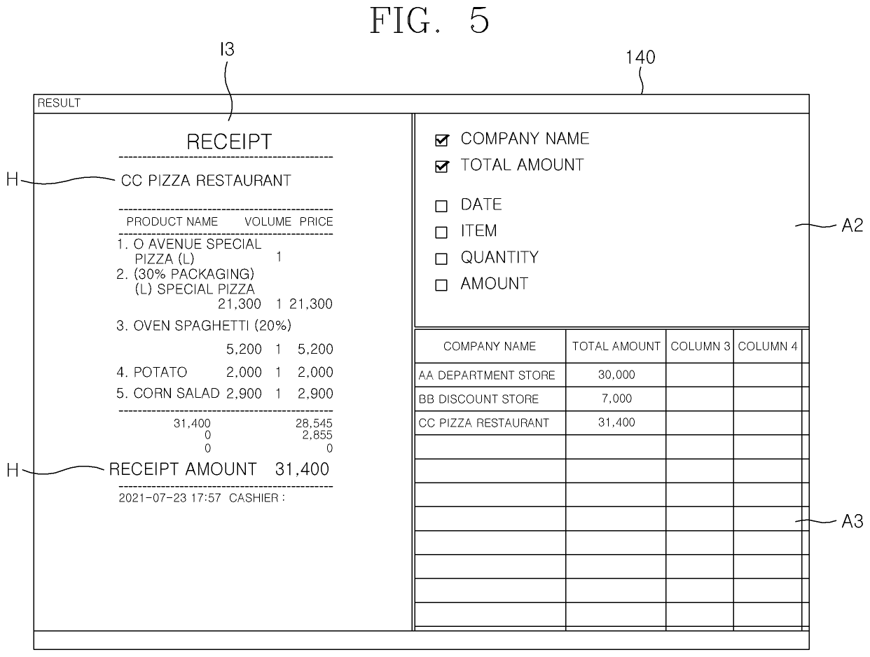

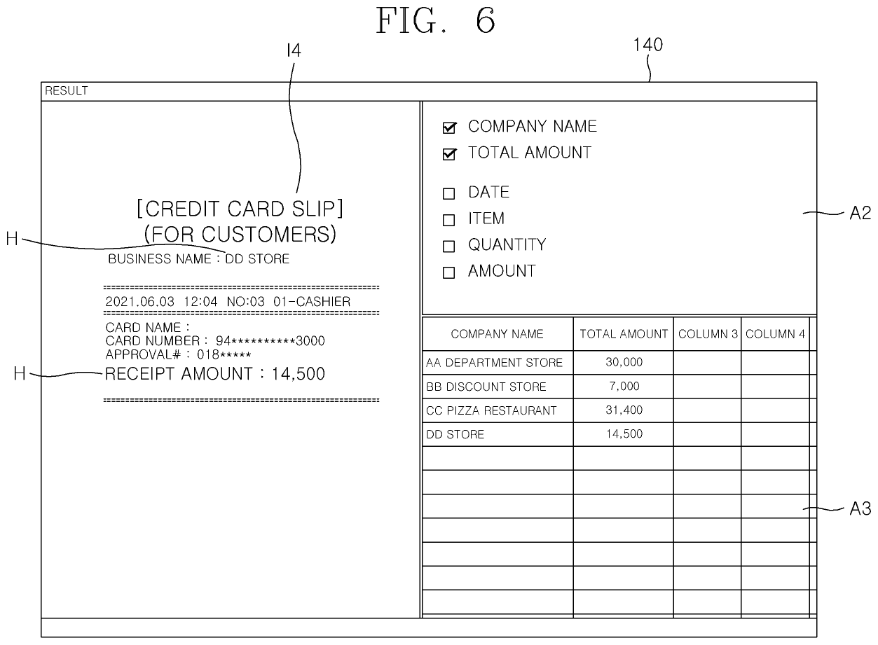

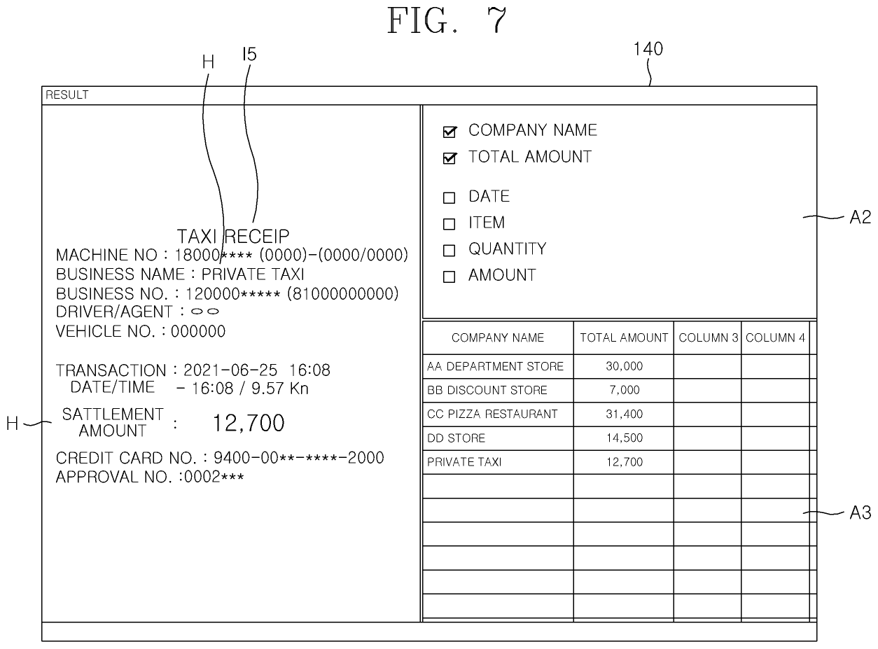

That is, when “Company Name” and “Total Amount” are configured as a basic item for an output item, as shown in FIG. 3, “AA department store” and “30,000” may be added to a table with respect to the first receipt Il. Thereafter, as shown in FIG. 4, when a second receipt 12 is added, “BB discount store” and “7,000” may be extracted from the second receipt I2 and added to a table. Furthermore, as shown in FIG. 5 to FIG. 7, when a third receipt I3 to a fifth receipt I5 are added, “CC Pizza Restaurant” and “31,400”, “DD Store” and “14,500”, and “Private Taxi” and “12,700” may be extracted and added to a table. As such, it is possible that a user sequentially inputs multiple receipts and identifies a total expenditure or the like by using the table. An expenditure or the like is identified through document recognition with respect to a receipt and thus it is possible to collectively combine and manage even when different credit cards are used or cash payment is performed.

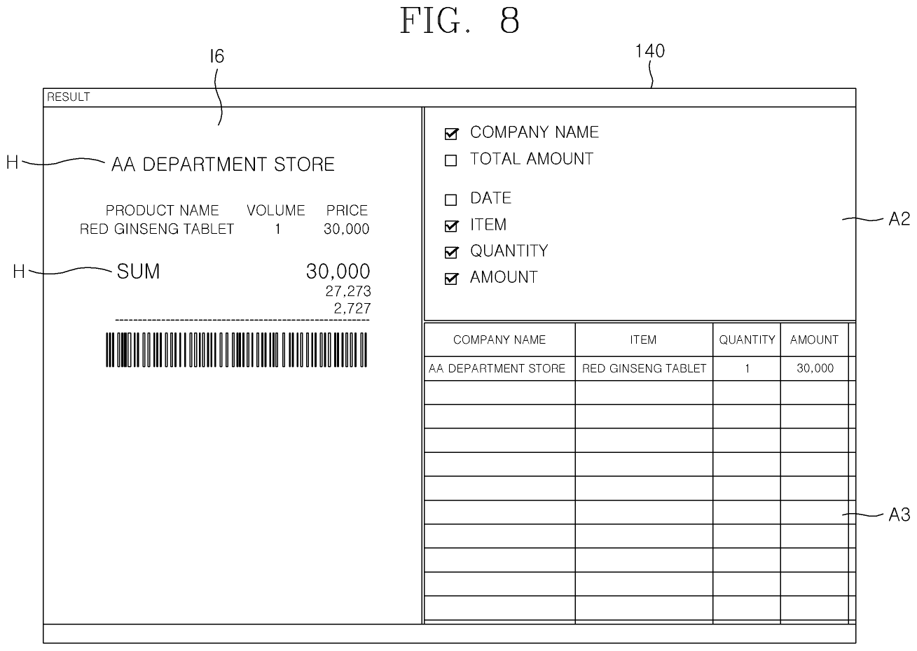

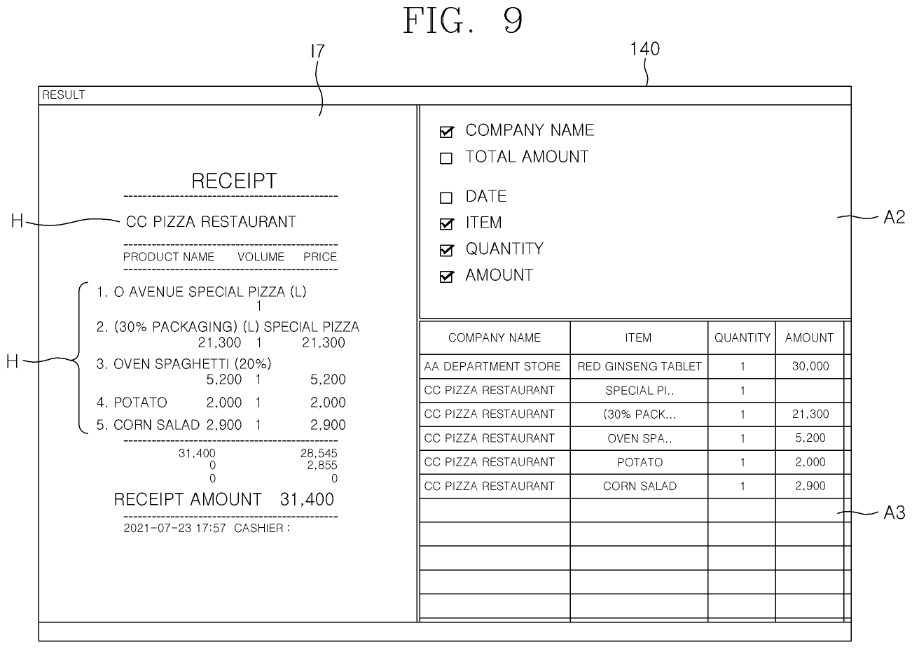

Additionally, the output item may vary depending on the user's settings, etc. and in this case, the table may be accumulated and generated as shown in FIG. 8 and FIG. 9. Referring to FIG. 8, it may be identified that among output items, “Total Amount” is deselected and “Item”, “Quantity”, and “Amount” are selected and added.

Here, the calculation part 130 may search for a key value corresponding each of “Company Name”, “Item”, “Quantity”, and “Amount” from the sixth receipt I6 and search for a key-value pair corresponding to the key value, and may extract a value from the searched key-value and configure the value as a value corresponding to the output item. The output item “Company Name”corresponds to the key value “Business name” and the value “AA department store” corresponding to “Business name” may be extracted. In addition, an output item “Item”corresponds to the key value “Product name” and “Red ginseng tablet” may be extracted and added to the table as a value corresponding to “Item”. As the output item “Quantity”corresponds to a key value “Volume” and the output item “Amount” corresponds to “Price”, “1” may be extracted as a value corresponding to “Quantity”and a value “30,000” corresponding to “Amount” is extracted so as to be added to the table.

Thereafter, as shown in FIG. 9, when a seventh receipt 17 is added, the calculation part 130 may search for a key value corresponding to each of “Company Name”, “Item”, “Quantity”, and “Amount” and extract a key-value pair having the key value in the same manner. The output item “Company Name” may correspond to the key value “Business name”and the value “CC pizza restaurant” corresponding to “Business name” may be extracted. Furthermore, the output item “Item” corresponds to the key value “Product name”, and “O Avenue Special Pizza (L)”, “(30% packaging) (L) Special Pizza”, “Oven Spaghetti (20%)”, “Potatoes”, “Corn Salad”, as values corresponding to “Item”, may be respectively extracted and added to the table. The output item “Quantity” corresponds to the key value “Volume” and the output item “Amount” correspond to the key value “Price”, and thus “1”, “1”, “1”, “1”, and “1” may be extracted as values corresponding to “Quantity” and “21,300”, “5,200”, “2,000”, and “2,900” may be extracted as values corresponding to “Amount” so as to be added to the table.

The display part 140 may display the first image, the table, and the like received from the calculation part 130 to visually provide same to a user. Referring to FIG. 3, the display part 140 may display the first image provided from the calculation part 130 in the selection image area A1 and display the list of the output items and the selection object S for each output item in the item display area A2. Furthermore, the table may be displayed in the table area A3. A size, arrangement, or the like of each of the selection image area A1, the item display area A2, and the table area A3 may be configured by the calculation part 130 and the size, arrangement, or the like may vary according to an embodiment.

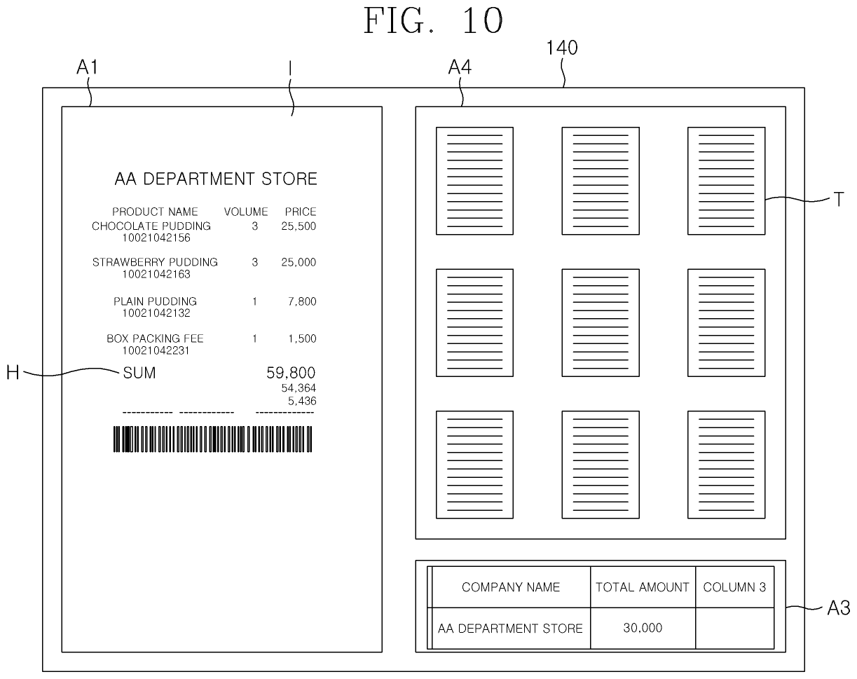

Depending on an embodiment, as shown in FIG. 10, an initial page may be output and, in this case, a thumbnail display area A4 which displays multiple document images input by a user to the document recognition apparatus 100 in a thumbnail image T may be displayed. Thereafter, when a user selects one from among multiple thumbnail images T included in the thumbnail display area A4, a document image I corresponding to the selected thumbnail image T may be displayed in the selection image area A1. Thereafter, a key-value pair corresponding to an output item may be extracted from the document image I in the selection image area A1 to generate a table. The generated table may be displayed in the table area A3 and the first image may be displayed in the selection image area A1.

According to an embodiment, it is possible that when an input of a user with respect to the selection image area A1 is authorized, the document image I displayed in the selection image area A1 is changed. The document image I may appear sequentially in the order of document images corresponding to the thumbnail image T appearing in the thumbnail display area A4. For example, it is possible that when a user authorizes a click input in the selection image area A1, the document images in the following order among the document images in the thumbnail display area A4 may be displayed. Alternatively, it is possible that when swiping from left to right within the selection image area A1, the next image among documents images in the thumbnail display area A4 is displayed, and when swiping from right to left, the previously displayed image is displayed again. Various modifications are possible, such as swiping up and down instead of swiping left and right.

Additionally, selection of multiple output items included in the item display area A2 may be made or released by clicking the selection object S shown in FIG. 3. According to an embodiment, selection and deselection may be performed by a drag & drop method. For example, an output item may be selected by a method of selecting the output item desired to be selected from among the output items and dropping same in the table area A3. Furthermore, it is possible to deselect an output item by a method of dragging a column of the selected item included in the table and dropping same to the outside of the table.

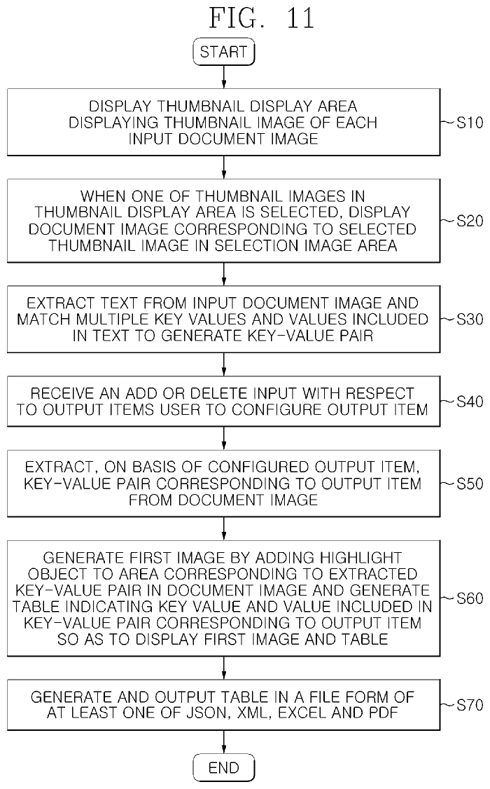

FIG. 11 is a flowchart illustrating a method for displaying a document recognition result according to an embodiment of the present disclosure. Each operation of the method for displaying a document recognition result may be performed by the document recognition apparatus 100 or the computing apparatus 12 mentioned in the description related to the FIG. 1 and/or FIG. 12 and the accompanying drawings.

Referring to FIG. 11, the document recognition apparatus may display a thumbnail display area displaying a thumbnail image of each input document image (S10). That is, the document recognition apparatus may receive multiple document images and convert the received document images into thumbnail images and display same in the thumbnail display area. A user may select a thumbnail image to extract text therefrom from among thumbnail images displayed in the thumbnail display area.

Thereafter, when one of thumbnail images in the thumbnail display area is selected, the document recognition apparatus may display a document image corresponding to the selected thumbnail image in the selection image area (S20). According to an embodiment, it is possible that when an input of a user with respect to the selection image area is authorized, the document image I displayed in the selection image area is changed. For example, it is possible that when a user authorizes a click or swipe input within the selection image area, the document images in the following order among the document images included in the thumbnail display area may be displayed.

When a document image is selected, the document recognition apparatus may extract text from the input document image and match multiple key values and values included in the text to generate key-value pairs (S30). The document recognition may recognize and extract text in the document image by using a document recognition algorithm such as OCR. Relationship between the key values and the values included in the text may be matched through a preconfigured rule or a neural network model-based machine learning. The key-value pairs may be matched considering a position, semantic similarity, or the like between each key value and value. When a key value is omitted from the document, it is possible to create a key value and match the key value with a value.

Thereafter, when an add or delete input with respect to output items is received from a user, the document recognition apparatus may configure an output item (S40). The output item corresponds to an item desired to be displayed to a user among texts included in the document image. Among the output items, basic items to be displayed to a user may have been configured. According to feedback of a user, it is possible to add other items in addition to the basic items or delete or modify at least a portion of the basic items to update output items. That is, the document recognition apparatus may receive an add or delete input with respect to output items from a user and modify and configure the output items according thereto. For example, the document recognition apparatus may generate an item display area including a list of output items and a selection object with respect to each output item and provide same to a user. As such, a user may easily identify output items from the item display area and select or deselect desired output items.

Thereafter, the document recognition apparatus may extract, on the basis of a configured output item, a key-value pair corresponding to the output item from the document image (S50). The document recognition apparatus may search for a key-value pair having a key value corresponding to the output item among the key-value pairs and extract the key-value pair.

However, each document image may be non-standardized and thus terms used in the document images may be different from each other. That is, for the same output item, respective document images may use different terms. Here, when the document recognition apparatus uses only the text extracted from the document image, searching for a key value corresponding to an output item may fail.

In order to prevent the above-described problem, the document recognition apparatus may use a concordance mapping DB. That is, words of the document image, which correspond to the same output item are stored in the concordance mapping DB, and thus when key values corresponding to the output item is searched by using the preconfigured concordance mapping DB, it is possible to extract a key-value pair corresponding to the output item.

Thereafter, the document recognition apparatus may add a highlight object to an area corresponding to the extracted key-value pair in the document image to generate a first image and display the first image (S60). That is, the highlight object is added to visually display the selected output item in the document image to a user so as to generate the first image. The highlight object may correspond to adding a highlight, a bounding box, shading, or the like to an area corresponding to an output item. In addition, when a user adds or deletes an output item or the like, the document recognition apparatus may modify and display a location of the highlight object in the first image according to the modified output item.

The document recognition apparatus may generate a table indicating a key value and a value included in the key-value pair corresponding to the output item and displaying the first image by further including the table (S60). That is, by providing an output item that a user wants to check through a separate table, it is possible to conveniently provide information required by the user among various information included in the document image.

Additionally, multiple documents may be input to the document recognition apparatus, and in this case, the document recognition apparatus may accumulate and display a key value and a value corresponding to the key-value pair extracted from the added document image in the table.

Thereafter, the document recognition apparatus may generate and output the generated table in a file form such as JSON, XML, Excel and PDF (S70). That is, a user may request the document recognition apparatus to provide information corresponding to the table in a file form, and in this case, the document recognition apparatus may convert the generated table into a file form and provide same to the user. The file form provided by the document recognition apparatus may be variously changed according to an embodiment.

FIG. 12 is a block diagram illustrating a computing environment 10 suitable for use in exemplary embodiments. In the embodiment disclosed herein, each component may have different functions and capabilities other than those described below, and may include additional components in addition to those described below.

The computing environment 10 disclosed herein includes the computing apparatus 12. In an embodiment, the computing apparatus 12 may be an apparatus for classifying a document (e.g., the document recognition apparatus 100).

The computing apparatus 12 includes at least one processor 14, a computer-readable storage medium 16, and a communication bus 18. The processor 14 may cause the computing apparatus 12 to be operated according to the above-described exemplary embodiment. For example, the processor 14 may execute at least one program stored in the computer-readable storage medium 16. The at least one program may include one or more computer-executable instructions, and the computer-executable instructions may be configured to cause, when executed by the processor 14, the computing apparatus to perform operations according to an exemplary embodiment.

The computer-readable storage medium 16 is configured to store a computer-executable instruction or program code, program data and/or other suitable form of information. A program 20 stored in the computer-readable storage medium 16 includes a set of instructions executable by the processor 14. In an embodiment, the computer-readable storage medium 16 may include a memory (volatile memory, such as random-access memory, non-volatile memory, or a suitable combination thereof), one or more magnetic disk storage devices, optical disk storage devices, flash memory devices, another form of storage medium accessible by the computing device 12 and capable of storing desired information, or suitable combinations thereof.

The communication bus 18 may mutually connect various components of the computing apparatus 12 including the processor 14 and the computer-readable storage medium 16.

The computing apparatus 12 may include one or more input/output interfaces 22 providing an interface for one or more input/output apparatus 24, and one or more network communication interface 26. The input/output interface 22 and the network communication interface 26 are connected to the communication bus 18. The input/output apparatus 24 may be connected to other components of the computing apparatus 12 through the input/output interface 22. The exemplary input/output apparatus 24 may include an input apparatus, such as pointing apparatus (a mouse, a trackpad, or the like), a keyboard, a touch input apparatus (a touchpad, a touchscreen, or the like), a voice or sound input apparatus, various types of sensor apparatus and/or imaging apparatus, and/or a display apparatus, and an output apparatus such as a printer, a speaker and/or a network card. The exemplary input/output apparatus 24 may be included in the computing apparatus 12 as a component constituting the computing apparatus 12 and may be connected to the computing apparatus as a separate apparatus distinct from the computing apparatus 12.

The present disclosure described above may be implemented as a computer-readable code in a medium in which a program is recorded. The computer-readable medium may continuously store a computer-executable program, or may temporarily store a computer-executable progam for execution or download. Furthermore, the medium may be various recording means or storage means in a form of a single hardware or a combination of several hardware, may be not limited to a medium directly connected to any computer system, and may exist on a network while being dispersed. An example of the recording medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the recording medium may include an application store in which applications are distributed, a site in which other various pieces of software are supplied or distributed, and recording media and/or storage media managed in a server or the like. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

The present disclosure is not limited by the above-described embodiments and the accompanying drawings. For those of ordinary skill in the art to which the present disclosure pertains, it will be apparent that the components according to the present disclosure can be substituted, modified, and changed without departing from the technical spirit of the present disclosure.

What is claimed is:

1. A method performed by a processor in a computing apparatus for displaying a document recognition result, the method comprising:
extracting text from an input document image and matching multiple key values and values included in the text to generate key-value pairs;
on the basis of a configured output item, extracting a key-value pair corresponding to the output item from the document image; and
adding a highlight object to an area corresponding to the extracted key-value pair in the document image to generate a first image and displaying the first image.

2. The method of claim 1, wherein in the displaying the first image, a table indicating a key value and a value included in the key-value pair corresponding to the output item is generated and is additionally included in the displayed first image.

3. The method of claim 2, wherein in the displaying the first image, when the input document image is added, a key value and a value corresponding to the key-value pair extracted from each document image are accumulated to the table.

4. The method of claim 2, further comprising generating and providing the table in a file form of at least one of JSON, XML, Excel, and PDF.

5. The method of claim 1, wherein in the extracting a key-value pair, a key-value pair having a key value corresponding to the output item is searched from among the key-value pairs to extract the key-value pair.

6. The method of claim 5, wherein in the extracting a key-value pair, a key value corresponding to the output item is searched by using a preconfigured concordance mapping DB and a key-value pair corresponding to the output item is extracted by using the searched key value.

7. The method of claim 1, further comprising receiving an add or delete input with respect to the output item from a user and configuring the output item.

8. The method of claim 7, wherein in the configuring the output item, the list of the output items and an item display area including a selection object for adding or deleting output items to/from the list are additionally added to be displayed.

9. The method of claim 1, further comprising:
displaying a thumbnail display area for displaying a thumbnail image of respective input document images; and
when one thumbnail image in the thumbnail display area is selected, displaying a document image corresponding to the selected thumbnail image within a selection image area.

10. A computer-readable storage medium which stores instructions that, when executed by a processor, cause an apparatus including the processor to perform operations for displaying a document recognition result,
wherein the operations comprise:
extracting text from an input document image and matching multiple key values and values included in the text to generate key-value pairs;
on the basis of a configured output item, extracting a key-value pair corresponding to the output item from the document image; and
adding a highlight object to an area corresponding to the extracted key-value pair in the document image to generate a first image and displaying the first image.

11. The computer-readable storage medium of claim 10, wherein in the displaying the first image, a table indicating a key value and a value included in the key-value pair corresponding to the output item is generated and is additionally included in the displayed first image.

12. The computer-readable storage medium of claim 11, wherein in the displaying the first image, when the input document image is added, a key value and a value corresponding to the key-value pair extracted from each document image are accumulated to the table.

13. A document recognition apparatus comprising a processor,
wherein the processor is configured to perform:
extracting text from an input document image and matching multiple key values and values included in the text to generate key-value pairs;
on the basis of a configured output item, extracting a key-value pair corresponding to the output item from the document image; and
adding a highlight object to an area corresponding to the extracted key-value pair in the document image to generate a first image and displaying the first image.

14. The document recognition apparatus of claim 13, wherein in the displaying the first image, a table indicating a key value and a value included in the key-value pair corresponding to the output item is generated and is additionally included in the displayed first image.

15. The document recognition apparatus of claim 14, wherein in the displaying the first image, when the input document image is added, a key value and a value corresponding to the key-value pair extracted from each document image are accumulated to the table.

16. The document recognition apparatus of claim 14, wherein the processor is configured to further perform generating and providing the table in a file form of at least one of JSON, XML, Excel, and PDF.

17. The document recognition apparatus of claim 13, wherein in the extracting a key-value pair, a key-value pair having a key value corresponding to the output item is searched from among the key-value pairs to extract the key-value pair.

18. The document recognition apparatus of claim 17, wherein in the extracting a key-value pair, a key value corresponding to the output item is searched by using a preconfigured concordance mapping DB and a key-value pair corresponding to the output item is extracted by using the searched key value.

19. The document recognition apparatus of claim 13, wherein the processor is configured to further perform receiving an add or delete input with respect to the output item from a user and configuring the output item.

20. The document recognition apparatus of claim 19, wherein in the configuring the output item, the list of the output items and an item display area including a selection object for adding or deleting output items to/from the list are additionally added to be displayed.
